(19) United States
(12) Patent Application Publication
(10) Pub. No.: US 2026/0147399 A1
(43) Pub. Date: May 28, 2026

(54) Processor Frequency Control For Expected Demand

(71) Applicant: Advanced Micro Devices, Inc., Santa Clara, CA (US)

(72) Inventors: Wonje Choi, Austin, TX (US); Indrani Paul, Austin, TX (US)

(73) Assignee: Advanced Micro Devices, Inc., Santa Clara, CA (US)

(21) Appl. No.: 18/958,270

(22) Filed: Nov. 25, 2024

(51) Int. Cl. G06F 1/324; G06F 1/3206; G06F 9/50

(52) U.S. Cl. CPC G06F 1/324; G06F 1/3206; G06F 9/50

(57) ABSTRACT

Processor frequency control for expected demand is described. In one or more implementations, an apparatus includes a processing system that executes instructions for satisfying a workload demand for a current window of time, and a power management circuit that controls a processor frequency of the processing system based on one or more characteristics of the workload demand for an earlier window of time. In at least one example, a system includes a memory including executable instructions of a workload, and a processor that executes the instructions for a second window of time according to a processor frequency that is controlled based on one or more characteristics of the instructions for a first window of time.

### BACKGROUND

A computing system adjusts a processor frequency (e.g., operating frequency, execution frequency) of a central processing unit (CPU) to meet fluctuations in workload demand. Conventional systems are slow to react to sudden workload changes. Performance suffers and power is wasted when processor frequency control is not responsive to bursty, or erratic CPU demands.

### BRIEF DESCRIPTION OF THE DRAWINGS

FIG. 1 is a block diagram of a non-limiting example processing system configured to execute one or more applications for implementing processor frequency control for expected demand.

FIG. 2 is a block diagram of a non-limiting example system for implementing processor frequency control for expected demand.

FIG. 3 is a timing diagram of a non-limiting example system that implements processor frequency control for expected demand.

FIG. 4 is a flow diagram illustrating an example process for implementing processor frequency control for expected demand.

FIG. 5 is a flow diagram illustrating an example process for implementing processor frequency control for expected demand.

### DETAILED DESCRIPTION

Various computing systems include a central processing unit (CPU) for executing instructions of workloads (e.g., applications, threads, services). Workload demands for a CPU tend to be bursty, changing frequently over time in size, occurrence, and complexity. Intervals of low or zero CPU demand are interspersed with periods of high CPU demand. The variability of CPU demand contrasts with demand for other types of processors, such as a graphic processing unit (GPU), which remains steady over time.

To improve performance and power management, the execution frequency of the CPU is adjusted to meet demand. When the CPU does not execute at a sufficiently high frequency, performance suffers as the CPU struggles to satisfy peaks of the workload demand. Likewise, power is wasted when demand drops, and the CPU continues operating at a higher-than-normal execution frequency. The execution frequency of the CPU is adjusted higher or lower to efficiently satisfy increased or reduced demand. Between CPU workloads, when there is no demand for the CPU, the execution frequency is reduced to idle (e.g., zero, near zero) to conserve power.

Conventional systems are slow to react to sudden workload demand changes. Increases in the execution frequency lag behind increases in workload demand, and vice versa. For example, the CPU fails to operate at a higher execution frequency when the workload demand peaks, or the execution frequency takes too long to ramp down after the workload demand has dropped. Performance suffers and power is wasted when CPU execution frequency is not precisely controlled to coincide with changes in workload demand.

In contrast to conventional systems, processor frequency control for expected demand is described. Rather than chase demand peaks and valleys to eventually meet workload demand, characteristics of previous workload demand is analyzed to anticipate processor frequency adjustments. A processor frequency (e.g., an operational frequency, an execution frequency) used for executing a future workload is compensated based on the previous workload characteristics to balance achieving high performance with a reduced energy consumption.

In one or more implementations, an apparatus includes a processing system that executes instructions of a workload according to a specific processor frequency. For example, a central processing unit (CPU) executes a mobile application at a given operating frequency or execution frequency. This processor frequency of the CPU is carefully managed to meet workload demand and conserve battery resources. A power manager (e.g., a power management circuit), for instance implemented in hardware, software, firmware, or combination thereof, actively tunes the processor frequency to satisfy workload demands of the mobile application, which like other CPU traffic is highly erratic at times.

To avoid causing drastic (e.g., frequent, high magnitude) adjustments to the processor frequency in response to sudden bursts or pauses in workload demand, the power management circuit controls the processor frequency based on a broad monitoring view of the workload behavior. The power management circuit monitors characteristics of a workload execution during earlier windows of time to anticipate workload demands (and an appropriate processor frequency to use) for a current or upcoming window of time. For example, the power management circuit detects multiple spikes in the workload demand over fifty or one hundred iterations of a control loop. For example, a spike or demand spike occurs when a workload size exceeds a size threshold, which in one or more examples is based on the processor frequency (e.g., larger size threshold with a faster processor frequency, smaller size threshold with a slower processor frequency). If the number of demand spikes during the window exceeds a threshold number, then the frequency of the CPU is bumped up by the power management circuit during the next window. The power management circuit adjusts the processor frequency higher for improving performance during the next fifty or hundred control loop iterations. Alternatively, when multiple dips in the workload demand are detected, the processor frequency is adjusted lower to avoid wasting energy over processing the workload during subsequent rounds of control loop iterations. The processor frequency is not ramped down all the way to idle. Instead, the processor frequency is ramped down to a bumped-up floor frequency that is greater than zero (e.g., greater than idle frequency). The observation of spikes is then repeated for a next cycle and when the demand spikes pick back up, the CPU frequency is ramped back up to improve performance.

Based on the energy dips, energy spikes, or other characteristics of the workload detected during an earlier period of time, the processor frequency for a future window of time is adjusted to satisfy an expected demand, efficiently. In this way, by the time the workload demand for the CPU increases to an anticipated level, the processor frequency has already ramped up gradually to meet the expected demand. Little to zero lag exists between CPU demand peaks and processor frequency changes, without compromising too much power. Benefits of this solution may be more apparent with laptop and other mobile processor systems. Laptop CPUs generally have a wider range of processor frequencies (e.g., one to five gigahertz) than desktop CPUs (e.g., four to six gigahertz), which causes laptops to take more time to ramp up or down to meet demand. Controlling processor frequency for expected demand as described herein reduces this ramp up or ramp down time to noticeably improve laptop performance and battery life.

In some aspects, the techniques described herein relate to an apparatus including: a processing system that executes instructions for satisfying a workload demand for a current window of time, and a power management circuit that controls a processor frequency of the processing system based on one or more characteristics of the workload demand for an earlier window of time.

In some aspects, the techniques described herein relate to an apparatus, wherein the power management circuit selects the processor frequency from a plurality of predefined processor frequencies based on the characteristics.

In some aspects, the techniques described herein relate to an apparatus, wherein the power management circuit dynamically adjusts the processor frequency between a range of processor frequencies based on the characteristics.

In some aspects, the techniques described herein relate to an apparatus, wherein the characteristics include a count of demand spikes when the workload demand exceeds a size threshold during the earlier window of time.

In some aspects, the techniques described herein relate to an apparatus, wherein the characteristics include one or more of a size of each demand spike or an average size of the demand spikes.

In some aspects, the techniques described herein relate to an apparatus, wherein the power management circuit controls the processor frequency based on a function applied to the characteristics to select or dynamically adjust the processor frequency.

In some aspects, the techniques described herein relate to an apparatus, wherein the function sets the processor frequency for the current window of time to be a higher processor frequency than for the earlier window of time when the characteristics exceed a ceiling threshold.

In some aspects, the techniques described herein relate to an apparatus, wherein the function maintains the processor frequency at a current predefined processor frequency when the characteristics exceed a floor threshold that is set below the ceiling threshold.

In some aspects, the techniques described herein relate to an apparatus, wherein the function sets the processor frequency for the current window of time to be a lower processor frequency than for the earlier window of time when the characteristics do not exceed the floor threshold.

In some aspects, the techniques described herein relate to an apparatus, wherein the processing system includes a central processing unit, and the processor frequency includes a floor frequency of the central processing unit.

In some aspects, the techniques described herein relate to a system including: a memory including executable instructions of a workload, and a processor that executes the instructions for a second window of time according to a processor frequency that is controlled based on one or more characteristics of the instructions for a first window of time.

In some aspects, the techniques described herein relate to a system, wherein the characteristics include a count of demand spikes when demand of the workload exceeds a size threshold during the first window of time.

In some aspects, the techniques described herein relate to a system, wherein the characteristics include one or more of a size of each demand spike or an average size of the demand spikes.

In some aspects, the techniques described herein relate to a system, wherein the processor controls the processor frequency based on a function applied to the characteristics to select or dynamically adjust the processor frequency.

In some aspects, the techniques described herein relate to a system, wherein at least one of: the processor selects the processor frequency from a plurality of predefined processor frequencies based on the characteristics, or the processor dynamically adjusts the processor frequency between a range of processor frequencies based on the characteristics.

In some aspects, the techniques described herein relate to a system, wherein the function sets the processor frequency for the second window of time to be a higher processor frequency than for the first window of time when the characteristics exceed a ceiling threshold.

In some aspects, the techniques described herein relate to a system, wherein the function maintains the processor frequency at a current predefined processor frequency when the characteristics exceed a floor threshold that is set below a ceiling threshold for the first window of time.

In some aspects, the techniques described herein relate to a system, wherein the function sets the processor frequency for the second window of time to be a lower processor frequency than for the first window of time when the characteristics do not exceed a floor threshold that is set below a ceiling threshold for the first window of time.

In some aspects, the techniques described herein relate to a method including: establishing, by a processing system, a first processor frequency for executing instructions during a first window of execution time, executing, by the processing system and at the first processor frequency, first instructions of a workload during the first window of execution time, establishing, by the processing system, a second processor frequency for executing second instructions of the workload during a second window of execution time based on one or more characteristics of the first instructions, and executing, by the processing system and at the second processor frequency, the second instructions during the second window of execution time. In some aspects, the techniques described herein relate to a method, wherein establishing the second processor frequency includes controlling, by the processing system, the second processor frequency based on a function applied to the characteristics, the function causing the processing system to set the second processor frequency to be at least one of: a higher processor frequency than the first processor frequency when the characteristics exceed a ceiling threshold for the first window of execution time, the first processor frequency when the characteristics exceed a floor threshold for the first window of execution time that is set below the ceiling threshold, or a lower processor frequency than the first processor frequency when the characteristics do not exceed the floor threshold.

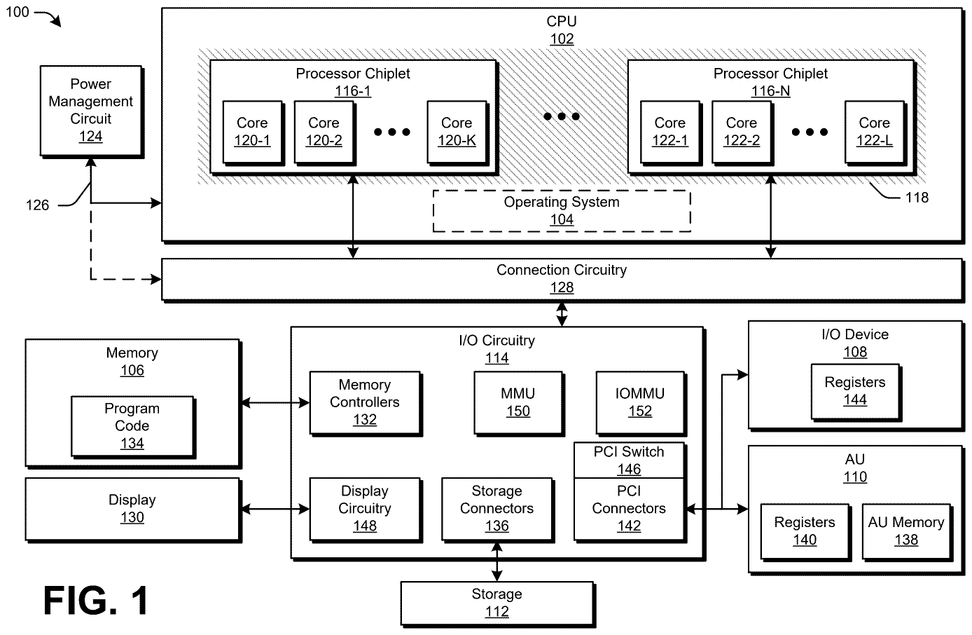

FIG. 1 is a block diagram of a processing system 100 configured to execute one or more applications, in accordance with one or more implementations. The processing system 100 is configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 112, I/O circuitry 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations.

Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

In this example, a power management circuit (PMC), which is labeled and referred to throughout this disclosure as power management circuit 124, is depicted just outside the CPU 102. A power management interface 126 is established directly with the CPU 102 or indirectly, e.g., via intermediary connection circuitry arranged between the power management circuit 124 and the CPU. In variations, however, the power management circuit 124 and the power management interface 126 are included in and/or implemented by one or more components of the processing system 100, such as the CPU 102, the memory 106, the I/O device 108, the AU 110, the storage 112, the I/O circuitry 114, and so forth. In at least one implementation, the power management circuit 124 and the power management interface 126 or portions of the power management circuit 124 and the power management interface 126 are included in at least two of the depicted components of the processing system 100. By way of example, the power management circuit 124 and the power management interface 126 may be included in or otherwise implemented by two or more of the CPU 102, the operating system 104, and the connection circuitry 128.

Additionally, within the processing system 100, the CPU 102 is communicatively coupled to an I/O circuitry 114 by a connection circuitry 128. For example, each processor chiplet 116 of the CPU 102 is communicatively coupled to the I/O circuitry 114 by the connection circuitry 128. The connection circuitry 128 includes, for example, one or more data fabrics, buses, buffers, queues, and the like. The I/O circuitry 114 is configured to facilitate communications between two or more components of the processing system 100 such as between the CPU 102, system memory 106, display 130, universal serial bus (USB) devices, peripheral component interconnect (PCI) devices (e.g., I/O device 108, AU 110), storage 112, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 114 includes one or more memory controllers 132. These memory controllers 132, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 132 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 134 (e.g., an executable file) associated with the application from, for example, a storage 112 into system memory 106. This storage 112, for example, includes a non-volatile storage such as a flash memory, solid-state memory, hard disk, optical disc, or the like configured to store program code 134 for one or more applications.

To facilitate communication between the storage 112 and other components of processing system 100, the I/O circuitry 114 includes one or more storage connectors 136 (e.g., universal serial bus (USB) connectors, serial AT attachment (SATA) connectors, PCI Express (PCIe) connectors) configured to communicatively couple storage 112 to the I/O circuitry 114 such that I/O circuitry 114 is capable of routing signals to and from the storage 112 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 138. This AU memory 138, for example, includes any combination of one or more volatile memories and/or non-volatile memories, examples of which include caches, video RAM (VRAM), or the like. In one or more implementations, these compute units are also configured to execute these threads based on the data stored in one or more physical registers 140 of the AU 110.

To facilitate communication between the AU 110 and one or more other components of processing system 100, the I/O circuitry 114 includes or is otherwise connected to one or more connectors, such as PCI connectors 142 (e.g., PCIe connectors) each including circuitry configured to communicatively couple the AU 110 to the I/O circuitry such that the I/O circuitry 114 is capable of routing signals to and from the AU 110 to one or more other components of the processing system 100. Further, the PCIe connectors 142 are configured to communicatively couple the I/O device 108 to the I/O circuitry 114 such that the I/O circuitry 114 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 144 of the I/O device 108. In one or more implementations, such physical registers 144 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 142, and one or more other components of the processing system 100, the I/O circuitry 114 includes PCI switch 146. The PCI switch 146, for example, includes circuitry configured to route packets to and from the components of the processing system 100 connected to the PCI connectors 142 as well as to the other components of the processing system 100. As an example, based on address data indicated in a packet received from a first component (e.g., CPU 102), the PCI switch 146 routes the packet to a corresponding component (e.g., AU 110) connected to the PCI connectors 142.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 112, displays the scene on the display 130, or both. The display 130, for example, includes a cathode-ray tube (CRT) display, liquid crystal display (LCD), light emitting diode (LED) display, organic light emitting diode (OLED) display, or any combination thereof. To enable the processing system 100 to display a scene on the display 130, the I/O circuitry 114 includes display circuitry 148. The display circuitry 148, for example, includes high-definition multimedia interface (HDMI) connectors, DisplayPort connectors, digital visual interface (DVI) connectors, USB connectors, and the like, each including circuitry configured to communicatively couple the display 130 to the I/O circuitry 114. Additionally or alternatively, the display circuitry 148 includes circuitry configured to manage the display of one or more scenes on the display 130 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 114 includes memory management unit (MMU) 146 and input-output memory management unit (IOMMU) 148. The MMU 150 includes, for example, circuitry configured to manage memory requests, such as from the CPU 102 to the system memory 106. For example, the MMU 150 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 150 is configured to translate the virtual address indicated in the memory request to a physical address in the system memory 106 and to fulfill the request. The IOMMU 152 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 144 of the I/O device 108, the registers 140 of the AU 110, and/or the AU memory 138, the CPU 102 issues one or more MMIO requests. Such MMIO requests each request access to read, write, fetch, or pre-fetch data residing at one or more virtual addresses (e.g., guest virtual addresses) which each represent at least a portion of the registers 144 of the I/O device 108, the registers 140 of the AU 110, or the AU memory 138, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 152 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The 100 is configurable in a variety of ways with different combinations of components in accordance with the described techniques.

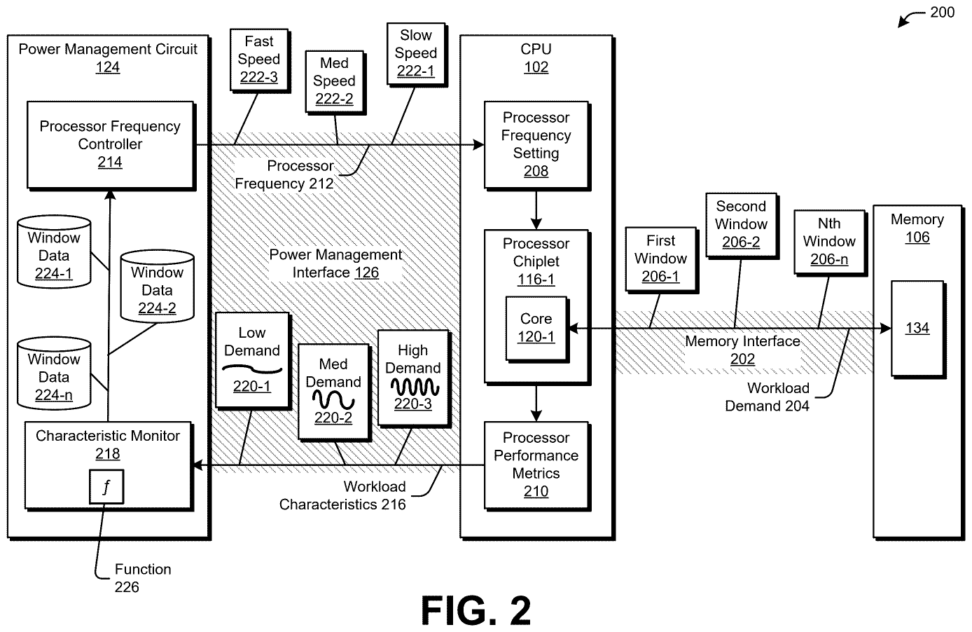

FIG. 2 is a block diagram of a non-limiting example system 200 for implementing processor frequency control for expected demand. The system 200 is described in the context of the processing system 100, including with reference to similarly numbered figure elements, such as the CPU 102, the processor chiplet 116-1, the core 120-1, the power management circuit 124, the power management interface 126, the connection circuitry 128, the memory 106, and the program code 134. Although illustrated as separate elements or circuits, in variations of the system 200, the power management circuit 124 is implemented as part of the same processing circuit as the CPU 102, and the power management interface 126 is implemented internal to the CPU 102. Likewise, the CPU 102 may be a graphics processing unit (GPU), an inference processing unit (IPU), the AU 110, or other processor implemented separate from the power management circuit 124 or combined with the power management circuit 124 in a single processing circuit.

The memory 106 of the system 200 shares a memory interface 202 with the CPU 102. For example, the memory interface 202 includes one or more connections implemented through the connection circuitry 128 via the memory controllers 132 and the I/O circuitry 114. The connections support upstream and downstream memory operations between the CPU and the memory 106. A workload demand 204 includes instructions of the program code 134 being fetched via the memory interface 202 to be executed by the CPU 102. The core 120-1 of the processor chiplet 116-1 processes the instructions received via the memory interface 202 to satisfy the workload demand 204.

The memory interface 202 is depicted in FIG. 2 as carrying the workload demand 204 during a plurality of different time windows, or execution intervals. For example, a first window 206-1 includes the instructions of the workload demand 204 that are executed by the CPU 102 earlier in time. A second window 206-2 includes the instructions of the workload demand 204 that are executed by the CPU 102 next in time, and an Nth window 206-n includes the instructions of the workload demand 204 that are currently being executed by the CPU 102.

The CPU 102 includes a processor frequency setting 208 and maintains processor performance metrics 210. The processor frequency setting 208 is a programmable or selectable parameter of the CPU 102 for configuring a processor frequency 212 (e.g., a floor frequency) used by the core 120-1 and the processor chiplet 116-1, such as to execute the instruction of the workload demand 204. The processor frequency setting 208, for example, is a processor parameter that configures a clock of the CPU 102 to operate at the processor frequency 212 to execute instructions.

In at least one example, the processor frequency setting 208 is set to the processor frequency 212, which is selected from a plurality of predefined processor frequencies, and in another example, the processor frequency 212 is adjustable between a range of processor frequencies. The processor frequency setting 208 may span a range of values to define a specific numeric operating frequency, including a floating point value defining the operating frequency to one or more decimal points. The CPU 102 has an operating frequency in at least one implementation that ranges from one to four gigahertz and the plurality of predefined processor frequencies usable as the processor frequency setting 208 include all values between one and four gigahertz at 500 megahertz intervals. In another implementation, the CPU 102 has an operating frequency that is finely tunable within a range of integer or decimal values (e.g., values between one and four gigahertz in addition to the values at the 500 megahertz intervals).

The power management circuit 124 includes a processor frequency controller 214 that sets the processor frequency 212 stored as the processor frequency setting 208. The processor frequency controller 214 sets the processor frequency 212 based on workload characteristics 216 derived from the processor performance metrics 210 and recorded by a characteristic monitor 218. The workload characteristics 216, for example, indicates that the first window 206-1 of instructions executed from the workload demand 204 represent low demand 220-1 for the computing resources (e.g., the processor chiplet 116-1 and the core 120-1) of the CPU 102. For the second window 206-2, the workload characteristics 216 indicate that the instructions associated with the workload demand 204 represent medium demand 220-2 for the computing resources. For the nth window 206-n, the workload characteristics 216 indicate that the instructions associated with the workload demand 204 represent high demand 220-3 for the computing resources.

The characteristic monitor 218 collects the workload characteristics 216 received from the power management interface 126 and outputs information (e.g., window data 224) used by the processor frequency controller 214 to set the processor frequency 212 for a next processing window. For example, based on the workload characteristics 216 obtained during the first window 206-1, the characteristic monitor 218 generates window data 224-1 for output to the processor frequency controller 214. The window data 224-1 includes information characterizing size and complexity of the workload demand 204 during the first window 206-1 as representing the low demand 220-1. The processor frequency controller 214 sets the processor frequency 212 to a slow speed 222-1 based on the window data 224-1. For example, the slow speed 222-1 is recorded by the processor frequency setting 208 as a low operating speed or energy conserving speed.

In at least one aspect, the window data 224 used by the processor frequency controller 214 to set the processor frequency 212 indicates a count of demand spikes when the workload demand 204 exceeds a size threshold during a corresponding window of time. For example, when a high burst of instructions are executed to satisfy the workload demand 204, the processor performance metrics 210 record processing statistics indicating a quantity of instructions and amount of data processed by the CPU 102 during that window of time. The performance metrics 210 include, in variations, a quantity of demand spiks that indicate how many times the size or amount of instructions of the workload demand 204 exceeded a performance threshold. In at least one example, the performance metrics 210 specify a size of each demand spike or an average size of the demand spikes for that window.

In continuing the example of FIG. 2, based on the workload characteristics 216 obtained during the second window 206-2, the characteristic monitor 218 generates window data 224-2 for output to the processor frequency controller 214. The window data 224-2 includes information characterizing size and complexity of the workload demand 204 during the second window 206-2 as representing the medium demand 220-2. The processor frequency controller 214 sets the processor frequency 212 to a medium speed 222-2 based on the window data 224-2. For example, the medium speed 222-2 is recorded by the processor frequency setting 208 as a balanced operating speed around performance and energy consumption.

Lastly in the example of FIG. 2, based on the workload characteristics 216 obtained during the nth window 206-n, the characteristic monitor 218 generates window data 224-n for output to the processor frequency controller 214. The window data 224-n includes information characterizing size and complexity of the workload demand 204 during the nth window 206-n as representing the high demand 220-3. The processor frequency controller 214 sets the processor frequency 212 to a fast speed 222-3 based on the window data 224-n. For example, the fast speed 222-3 is recorded by the processor frequency setting 208 as a high-performance operating speed that consumes a high amount of energy.

In at least one example, the characteristic monitor 218 relies on a function 226 applied to the workload characteristics 216 to enable the processor frequency controller 214 to select or dynamically adjust the processor frequency 212. For example, the function 226 causes the window data 224 output to the processor frequency controller 214 to set the processor frequency 212 for a current window of time to be a higher processor frequency than for an earlier window of time when the workload characteristics 216 exceed a ceiling threshold. That is, when the demand spikes are too frequent or too high in magnitude for a current processor frequency, the function 226 causes the processor frequency 212 to be set higher than the current processor frequency. If the processor frequency 212 is at the slow speed 222-1, for example, the processor frequency 212 is increased to the medium speed 222-2 or the fast speed 222-3.

In at least one example, the function 226 maintains the processor frequency 212 at a current predefined processor frequency when the workload characteristics 216 exceed a floor threshold that is set below the ceiling threshold. For instance, when the demand spikes are not too frequent or not too high in magnitude, the function 226 causes the processor frequency 212 to remain at a current processor frequency to continue to satisfy the workload demand 204. If the processor frequency 212 is at the slow speed 222-1, for example, the processor frequency 212 remains at the slow speed 222-1.

In at least one example, the function 226 sets the processor frequency 212 for a current window of time to be a lower processor frequency than for an earlier window of time when the workload characteristics 216 do not exceed the floor threshold. That is, when the demand dips are too frequent or deep, or when demand spikes occur infrequently or with low magnitudes, the function 226 causes the processor frequency 212 to be set lower than a current processor frequency. If the processor frequency 212 is at the medium speed 222-2, for example, the processor frequency 212 is decreased to the slow speed 222-1, which is faster than zero. The processor frequency 212 is lowered in anticipation of a reduced workload demand in an upcoming execution window.

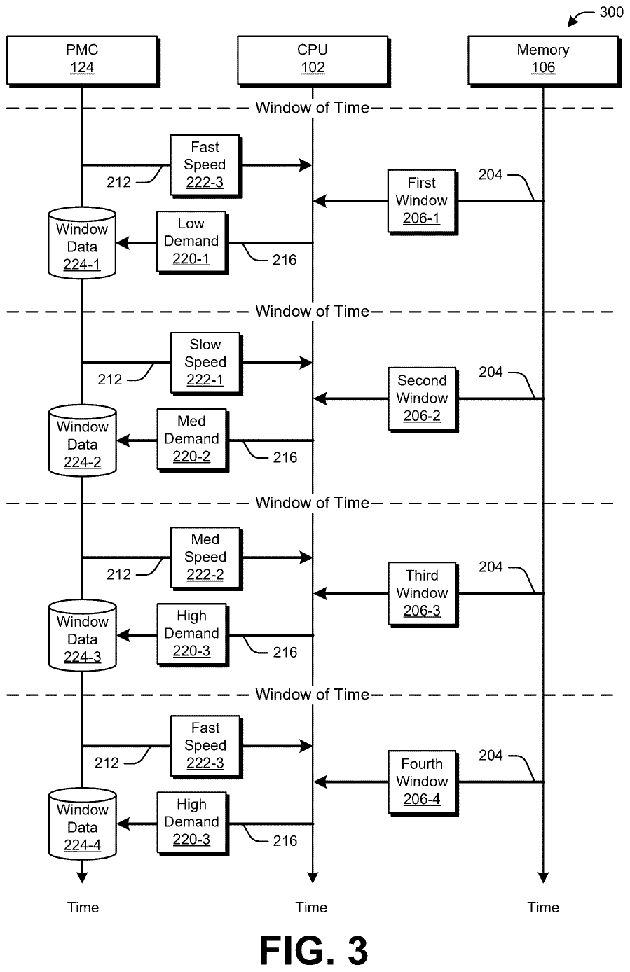

FIG. 3 is a timing diagram 300 of a non-limiting example of the system 200 implementing processor frequency control for expected demand. For ease of description, the diagram 300 is described in the context of the processing system 100 and the system 200. The timing diagram 300 includes three columns of actions taken by three different elements of the processing system 100 and the system 200, during four different time periods (e.g., windows of time) corresponding to the first window 206-1, the second window 206-2, a third window 206-3, and a fourth window 204-4.

In each of these different time periods, the CPU 102 is processing the workload demand 204 of the program code 134 stored by the memory 106. As the workload demand 204 is being processed, the CPU 102 is sharing the workload characteristics 216 with the power management circuit 124. The workload characteristics 216 are shared with the processor frequency controller 214 as the window data 224. Based on the window data 224 characterization of the CPU 102 performance processing the workload demand 204, the processor frequency controller 214 either increases, decreases, or refrains from adjusting the processor frequency 212 to improve performance during a subsequent window of time.

The window data 224-1 derived from the workload characteristics 216 received during the first window 206-1 characterizes the workload demand 204 to be the low demand 220-1. The processor frequency 212 is set to the fast speed 222-3 even though the CPU is experiencing the low demand 220-1.

During the second window 206-2, the processor frequency 212 is set to the slow speed 222-1 based on the CPU 102 experiencing the low demand 220-1 during an earlier time window (e.g., the first window 206-1). To reduce energy consumption by the CPU 102, the processor frequency 212 is throttled from the fast speed 222-3 to the slow speed 222-1. The window data 224-2 derived from the workload characteristics 216 received during the second window 206-2 characterizes the workload demand 204 to be the medium demand 220-2.

During the third window 206-3, the processor frequency 212 is set to the medium speed 222-2 based on the CPU 102 experiencing the medium demand 220-2 during an earlier time window (e.g., the second window 206-2). To balance energy consumption and improve performance of the CPU 102, the processor frequency 212 is ramped up from the slow speed 222-1 to the medium speed 222-2. The window data 224-3 derived from the workload characteristics 216 received during the third window 206-3 characterizes the workload demand 204 to be the high demand 220-3.

During the fourth window 206-4, the processor frequency 212 is set to the fast speed 222-3 based on the CPU 102 experiencing the high demand 220-3 during an earlier time window (e.g., the third window 206-3). To improve performance of the CPU 102, the processor frequency 212 is ramped up from the medium speed 222-2 to the fast speed 222-3. The window data 224-4 derived from the workload characteristics 216 received during the fourth window 206-4 characterizes the workload demand 204 to continue to be the high demand 220-3. During subsequent time windows, the processor frequency 212 is adjusted further to be faster when CPU demand is high and slower when CPU

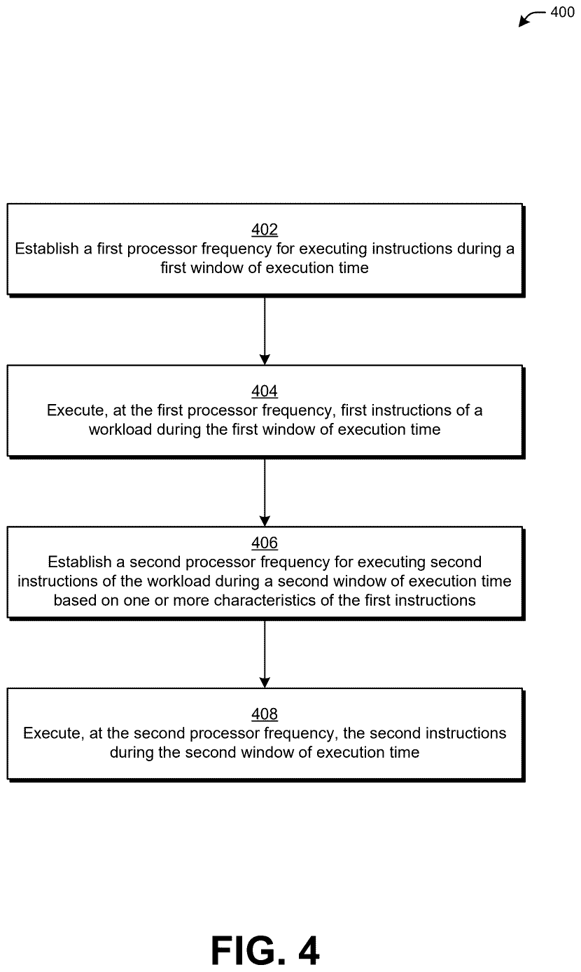

FIG. 4 is a flow diagram illustrating an example process 400 for implementing processor frequency control for expected demand. The process 400 starts at block 402, with establishing a first processor frequency for executing instructions during a first window of execution time. For example, the processor frequency controller 214 sets the processor frequency 212 for processing the workload demand 204 during the second window 206-2 at the slow speed 222-1 based on the window data 224-1 indicating the low demand 220-1 during the first window 206-1.

Next, at block 404, the process 400 includes executing, at the first processor frequency, first instructions of a workload during the first window of execution time. In one or more implementations, the CPU 102 process the workload demand 204 during the second window 206-2 at the slow speed 222-1.

At block 406, the process 400 includes establishing a second processor frequency for executing second instructions of the workload during a second window of execution time based on one or more characteristics of the first instructions. For example, the processor frequency controller 214 sets the processor frequency 212 for processing the workload demand 204 during the third window 206-3 at the medium speed 222-2 based on the window data 224-2 indicating the medium demand 220-2 during the second window 206-2.

In one or more examples, a function is applied to the workload characteristics 216 to control the processor frequency 212. For example, the processor frequency controller 214 uses the function applied to the workload characteristics 216 to determine whether the workload characteristics 216 and amount of demand (e.g., based on demand spike frequency, spike magnitude, demand spike averages) indicate switching to a higher or lower processor frequency. For example, the processor frequency 212 is controlled to meet expected demand for an upcoming window based on characteristics of the demand monitored for an earlier window. In at least one example, the function determines the processor frequency 212 based on whether the speed meets or exceeds the workload demand 204 assuming a recurrence of a percentage of the demand spiked observed previously. The processor frequency 212 is set based on the function to satisfy twenty five percent, forty percent, fifty percent, ninety percent, or some other proportion of the total demand spikes measured for the earlier window.

The processor frequency controller 214 sets the processor frequency 212 in the third window 206-1 to a higher processor frequency than in the second window 206-2 (e.g., the medium speed 222-2), when the workload characteristics 216 for the second window 206-2 exceed a ceiling threshold for that operating speed (e.g., the slow speed 222-1). The processor frequency controller 214 sets the processor frequency 212 in the third window 206-1 to a same frequency as the second window 206-2, when the workload characteristics 216 for the second window 206-2 exceed a floor threshold for the second window 206-2 that is set below the ceiling threshold. For example, the processor frequency controller 214 refrains from adjusting the processor frequency 212. In one or more implementations, the processor frequency controller 214 reduces the processor frequency 212 in the third window 206-1 to a lower processor frequency than in the second window 206-2 (e.g., the slow speed 222-1), when the workload characteristics 216 do not exceed the floor threshold and energy savings is possible.

Next at block 408, the process 400 includes executing, at the second processor frequency, the second instructions during the second window of execution time. In variations, the processing system 100 and the system 200 process the workload demand 204 with improved efficiency and performance. Energy consumption is balanced to address the dynamic and erratic behavior of the workload demand 204 using the CPU 102.

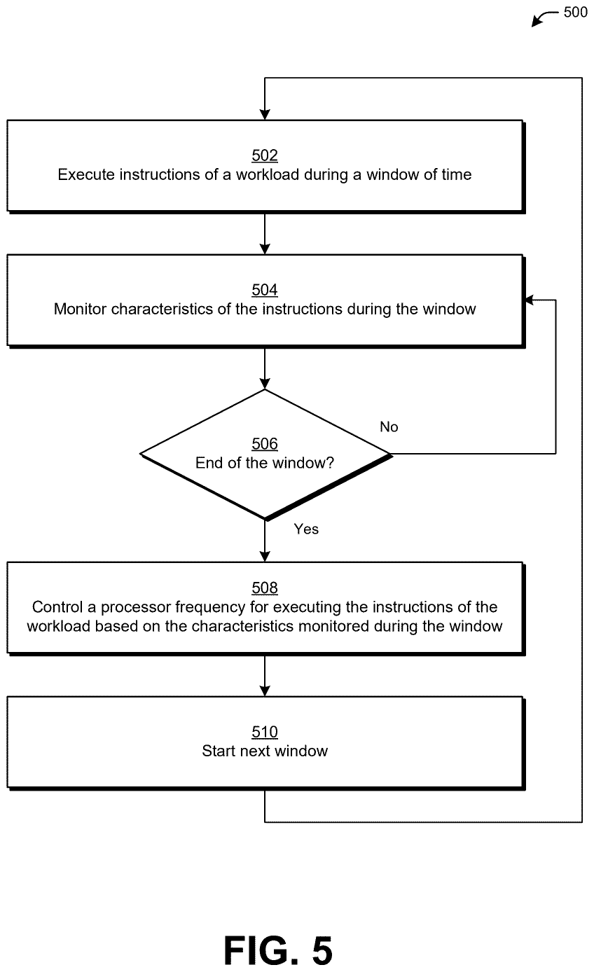

FIG. 5 is a flow diagram illustrating an example process 500 for implementing processor frequency control for expected demand. The process 500 starts at block 502, with executing instructions of a workload during a window of time. For example, the CPU 102 executes instructions of the workload demand 204 during the first window 206-1.

Next at block 504, the process 500 includes monitoring characteristics of the instructions during the window. For example, the processor frequency controller 214 receives the window data 224-1 generated by the characteristic monitor 218 based on the workload characteristics 216 received from the processor performance metrics 210.

The process 500 continues with block 506, where it is determined whether the time corresponds to the end of the window. For example, when the first window 206-1 is ongoing, the workload characteristics 216 are continuously being monitored and the process 500 loops back to the block 504. At the end of the first window 206-1, however, the process 500 continues from a YES path out of the block 506 and moves to block 508.

At block 508, the process 500 includes controlling a processor frequency for executing the instructions of the workload based on the characteristics monitored during the window. For example, the processor frequency controller 214 outputs the processor frequency 212 determined based on the window data 224-1 to increase to the medium speed 222-2 and improve performance when processing instructions of the workload demand 204 during the second window 206-2.

Lastly, at block 510 of the process 500, a next window is starts. For example, the process 500 repeats for the second window 206-2, including with the CPU 102 executing instructions during the second window 206-2, the power management circuit 124 monitoring the workload characteristics 216 during the second window 206-2, and the processor frequency controller 214 controlling the processor frequency 212 based on the window data 224-2 to configure the CPU 102 to efficiently meet the workload demand 204 expected for the third window 206-3.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (e.g., a power manager, the power management interface 126, the processor performance metrics 210, the processor frequency controller 214, the characteristic monitor 218, the program code 134) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a CPU, a Digital Signal Processor (DSP), a GPU, a parallel accelerated processor, a plurality of microprocessors, one or more microprocessors in association with a DSP core, a controller, a microcontroller, an Application Specific Integrated Circuit (ASIC), a Field Programmable Gate Array (FPGA) circuit, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read-only memory (ROM), a random-access memory (RAM), a register, cache memory, semiconductor memory devices, magnetic media such as internal hard disks and removable disks, magneto-optical media, and optical media such as a CD-ROM disk, or a digital versatile disk (DVD).

What is claimed is:

1. An apparatus comprising:
a processing system that executes instructions for satisfying a workload demand for a current window of time; and
a power management circuit that controls a processor frequency of the processing system based on one or more characteristics of the workload demand for an earlier window of time.

2. The apparatus of claim 1, wherein the power management circuit selects the processor frequency from a plurality of predefined processor frequencies based on the characteristics.

3. The apparatus of claim 1, wherein the power management circuit dynamically adjusts the processor frequency between a range of processor frequencies based on the characteristics.

4. The apparatus of claim 1, wherein the characteristics include a count of demand spikes when the workload demand exceeds a size threshold during the earlier window of time.

5. The apparatus of claim 4, wherein the characteristics include one or more of a size of each demand spike or an average size of the demand spikes.

6. The apparatus of claim 1, wherein the power management circuit controls the processor frequency based on a function applied to the characteristics to select or dynamically adjust the processor frequency.

7. The apparatus of claim 6, wherein the function sets the processor frequency for the current window of time to be a higher processor frequency than for the earlier window of time when the characteristics exceed a ceiling threshold.

8. The apparatus of claim 7, wherein the function maintains the processor frequency at a current predefined processor frequency when the characteristics exceed a floor threshold that is set below the ceiling threshold.

9. The apparatus of claim 8, wherein the function sets the processor frequency for the current window of time to be a lower processor frequency than for the earlier window of time when the characteristics do not exceed the floor threshold.

10. The apparatus of claim 1, wherein the processing system comprises a central processing unit and the processor frequency comprises a floor frequency of the central processing unit.

11. A system comprising:
a memory including executable instructions of a workload; and
a processor that executes the instructions for a second window of time according to a processor frequency that is controlled based on one or more characteristics of the instructions for a first window of time.

12. The system of claim 11, wherein the characteristics include a count of demand spikes when demand of the workload exceeds a size threshold during the first window of time.

13. The system of claim 12, wherein the characteristics include one or more of a size of each demand spike or an average size of the demand spikes.

14. The system of claim 11, wherein the processor controls the processor frequency based on a function applied to the characteristics to select or dynamically adjust the processor frequency.

15. The system of claim 14, wherein at least one of: the processor selects the processor frequency from a plurality of predefined processor frequencies based on the characteristics, or the processor dynamically adjusts the processor frequency between a range of processor frequencies based on the characteristics.

16. The system of claim 14, wherein the function sets the processor frequency for the second window of time to be a higher processor frequency than for the first window of time when the characteristics exceed a ceiling threshold.

17. The system of claim 14, wherein the function maintains the processor frequency at a current predefined processor frequency when the characteristics exceed a floor threshold that is set below a ceiling threshold for the first window of time.

18. The system of claim 14, wherein the function sets the processor frequency for the second window of time to be a lower processor frequency than for the first window of time when the characteristics do not exceed a floor threshold that is set below a ceiling threshold for the first window of time.

19. A method comprising:
establishing, by a processing system, a first processor frequency for executing instructions during a first window of execution time;
executing, by the processing system and at the first processor frequency, first instructions of a workload during the first window of execution time;
establishing, by the processing system, a second processor frequency for executing second instructions of the workload during a second window of execution time based on one or more characteristics of the first instructions; and
executing, by the processing system and at the second processor frequency, the second instructions during the second window of execution time.

20. The method of claim 19, wherein establishing the second processor frequency comprises controlling, by the processing system, the second processor frequency based on a function applied to the characteristics, the function causing the processing system to set the second processor frequency to be at least one of:
a higher processor frequency than the first processor frequency when the characteristics exceed a ceiling threshold for the first window of execution time;
the first processor frequency when the characteristics exceed a floor threshold for the first window of execution time that is set below the ceiling threshold; or
a lower processor frequency than the first processor frequency when the characteristics do not exceed the floor threshold.
